(19) United States
(12) Patent Application Publication
(10) Pub. No.: US 2017/0119611 A1
(43) Pub. Date: May 4, 2017

(54) CASKET AND METHOD FOR APPLYING AN OUTER LAYER WITH A CUSTOMIZABLE ARTWORK DESIGN TO FINISH THE CASKET

(71) Applicants: Giuseppe FORMUSO, Richmond Hill (CA); Rolando Oscar CARVALHO, Uxbridge (CA); Robert Marzilli, Richmond Hill (CA)

(72) Inventors: Giuseppe FORMUSO, Richmond Hill (CA); Rolando Oscar CARVALHO, Uxbridge (CA); Robert Marzilli, Richmond Hill (CA)

(21) Appl. No.: 14/930,835

(22) Filed: Nov. 3, 2015

(51) Int. Cl. A61G 17/04; A61G 17/007; G09F 23/00; B32B 27/32; B32B 3/30; B29C 65/48; B32B 21/08; B32B 27/08; B32B 7/12; B29C 51/10; B29C 51/26; B29C 51/42; A61G 17/02; B32B 15/085

(52) U.S. Cl. CPC A61G 17/04; A61G 17/02; A61G 17/007; A61G 17/0076; G09F 23/00; B32B 27/32; B32B 3/30; B32B 15/085; B32B 21/08; B32B 27/08; B32B 7/12; B29C 51/10; B29C 51/268; B29C 51/421; B29C 65/4805; G09F 2023/0025; B32B 2250/04; B32B 2255/26; B32B 2439/62; B29K 2023/06; B29L 2031/7126

(57) ABSTRACT

A casket comprising a casket underbody and an outer covering applied to the casket underbody to produce a finished casket. The casket underbody, i.e. casket lid and casket body, may be fabricated from lower cost wood, metal or plastic materials. The outer covering comprises a thin film and a base layer applied to the outer surface of the casket underbody. According to an embodiment, the outer covering may be customized or personalized according to the wishes or likes of the beloved deceased, or the family thereof, for example, the outer covering may be personalized with an artwork design for a favourite sport's team, or for a pet.

### FIELD OF THE INVENTION

The present invention relates to caskets and urns, and more particularly, to an economical casket or urn with a customizable outer covering, and a method for applying the outer covering to the casket or urn.

### BACKGROUND OF THE INVENTION

Funeral expenses continue to rise. A large part of the rising costs of a funeral are attributable to the cost of the casket or coffin, which can exceed $20,000. Traditional caskets are made from high quality hardwoods and/or metallic materials. In addition to the escalating labour costs associated with the fabrication of such caskets, the cost of the required materials continues to rise as well.

Accordingly, there remains a need for improvements in the art.

### BRIEF SUMMARY OF THE INVENTION

The present invention is directed to a casket or coffin comprising an underbody and an outer covering applied to the underbody to produce a finished casket.

According to an aspect, the underbody of the casket is fabricated from a lower cost material or materials.

According to another aspect, the outer covering is customizable to personalize or otherwise enhance the exterior appearance of the casket.

According to another aspect, a method or process is provided to apply the outer covering wherein the outer covering comprises a thin film, e.g. plastic, material.

According to a further aspect, the present invention comprises a computer program configured to generate a webpage or a website configured to allow an individual to select a casket design, or an urn design, and a personalized or customized outer covering according to their wishes or those of a loved one.

According to an embodiment, the present invention comprises a casket comprises: a casket body; a casket lid, the casket lid connected to the casket body; an outer-covering applied to one or more exterior surfaces of the casket body and the casket lid; the outer-covering comprising a carrier layer and a finished layer, the finished layer being applied to the carrier layer, and the carrier layer being formed to contours and shape of the one or more exterior surfaces, and the formed carrier layer and the finished layer being bonded to the one or more exterior surfaces of the casket underbody and the casket lid; and the finished layer comprising a customizable appearance.

According to another embodiment, the present invention comprises a method for fabricating a casket with a customized exterior treatment, the method comprises the steps of: fabricating a thin film layer; applying the thin film layer to a substrate layer; forming the substrate layer and the thin film layer to a shape corresponding to an exterior surface of the casket; bonding the formed substrate layer and the thin film to the exterior surface of the casket.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 is a perspective view of a casket fabricated with an outer covering personalized or customized for a sports fan according to an embodiment of the invention;

FIG. 2 is a perspective view of a casket fabricated with a personalized outer covering for a pet lover according to an embodiment of the invention;

FIG. 3 is flowchart showing a process or method for fabricating a casket with personalized or customized outer covering according to an embodiment of the present invention;

FIG. 4 shows in diagrammatic form an operation or step in the process or method for fabricating a casket with a personalized or customized outer covering of FIG. 3;

FIG. 5 shows in diagrammatic form an operation or step in the process or method for fabricating a casket with a personalized or customized outer covering of FIG. 3;

FIG. 6 shows in diagrammatic form an operation or step in the process or method for fabricating a casket with a personalized or customized outer covering of FIG. 3;

FIG. 7 shows in diagrammatic form an operation or step in the process or method for fabricating a casket with a personalized or customized outer covering of FIG. 3;

FIG. 8 shows in diagrammatic form an operation or step in the process or method for fabricating a casket with a personalized or customized outer covering of FIG. 3;

FIG. 9 shows in diagrammatic form an operation or step in the process or method for fabricating a casket with a personalized or customized outer covering of FIG. 3;

FIG. 10 shows in diagrammatic form an operation or step in the process or method for fabricating a casket with a personalized or customized outer covering of FIG. 3;

FIG. 11 shows in diagrammatic form an operation or step in the process or method for fabricating a casket with a personalized or customized outer covering of FIG. 3;

FIG. 12 shows in diagrammatic form an operation or step in the process or method for fabricating a casket with a personalized or customized outer covering of FIG. 3;

FIG. 13 is a screenshot of computer program for generating a web-based system configured to allow an individual to select a casket design and a personalized or customized outer covering according to another embodiment of the present invention; and

FIG. 14 is a block diagram showing an exemplary implementation for a computer system suitable for the casket order system of FIG. 13.

Like reference numerals indicate like or corresponding elements or components in the drawings.

### DETAILED DESCRIPTION OF THE EMBODIMENTS OF THE INVENTION

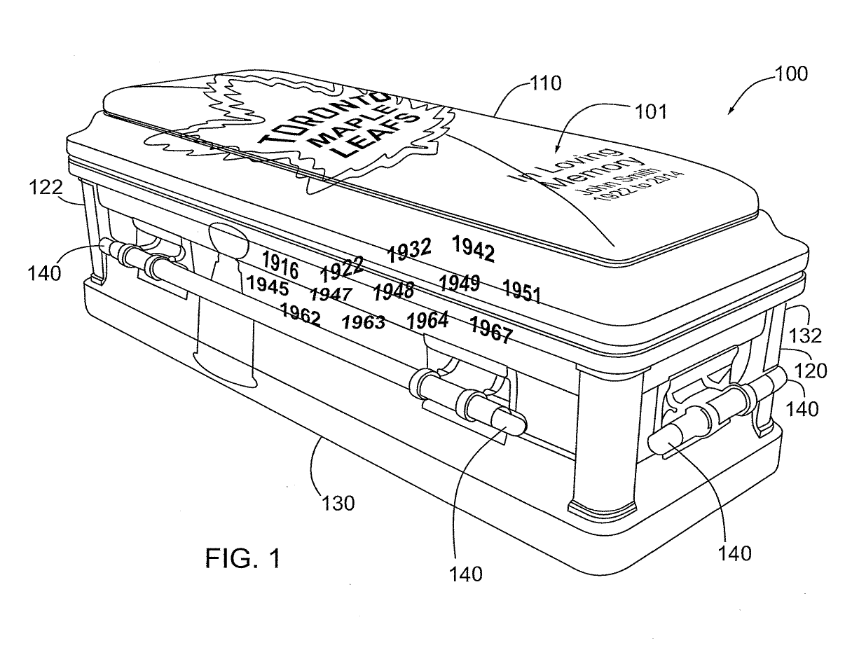

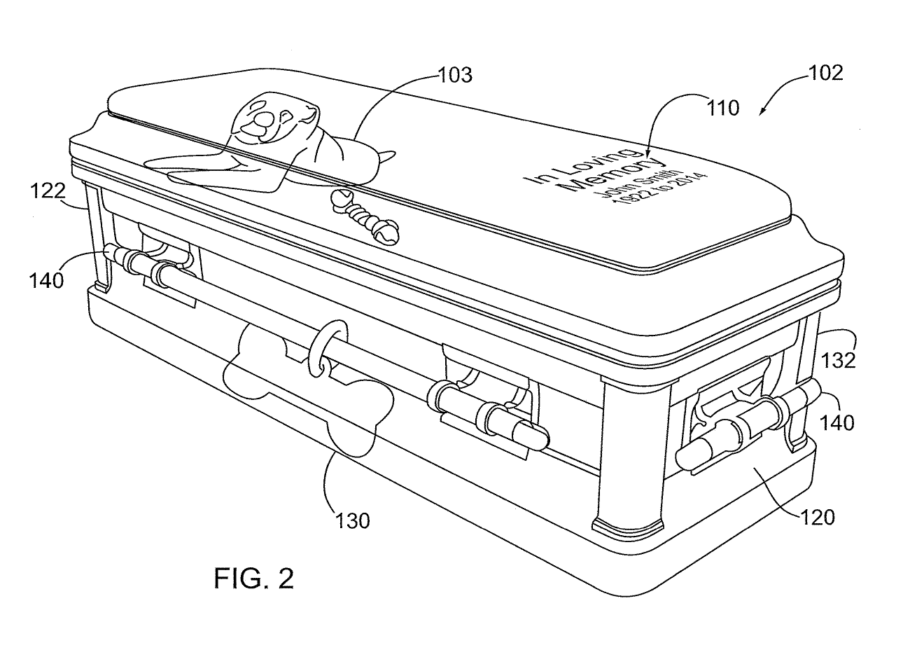

Reference is made to FIG. 1, which shows a perspective view of a casket or coffin according to an embodiment of the present invention and indicated generally by reference 100. As shown, the casket 100 comprises a top or lid 110, two end panels 120 and 122, and two side panels 130 and 132 (with only side being visible in the perspective view). As shown in FIG. 1, the casket 100 may include one or more handles indicated by reference 140 for carrying the casket 100. FIG. 2 shows a perspective view of a casket with a customized outer covering according to another exemplary implementation and indicated by reference 102.

According to an embodiment of the invention, the casket 100 comprises a casket underbody or inner casket as shown in FIG. 9 and indicated generally by reference 200 and a customized or personalized outer covering or layer as shown in FIG. 1 and indicated by reference 101. The personalized outer covering depicted in FIG. 1 comprises a sport's theme, for example, based on the Toronto Maple Leafs NHL hockey team. FIG. 2 shows a casket indicated generally by reference 102 comprising an outer covering 103 personalized or customized according to a pet (e.g. dog) theme for the beloved deceased.

As shown in FIG. 9, the casket 200 comprises a body or compartment 210 and a casket lid or top 220. The casket 200 also includes carrying handles or rails 230, indicated individually by references 230A and 230B, in FIG. 9. The casket body 210, the casket lid 220, and the handles 230 are assembled in known manner, as will be readily understood by one skilled in the art.

According to another embodiment and aspect of the present invention, the inner casket or casket underbody 200 is fabricated from lower cost wood materials instead of the expensive hardwoods (for example, oak, cherry and maple) used in the fabrication of traditional caskets. Suitable lower cost wood materials include particle board panels, pre-formed contoured elements fabricated from particle board, pressure treated wood, or plastic material, and joined or attached to the panels, for example, using suitable adhesives and other techniques, as will be understood by those skilled in the art. According to an embodiment of the invention, the casket underbody 200 is finished with an outer covering or customized treatment as discussed in more detail below.

According to another embodiment, the casket underbody 200 comprises a casket body 210 and/or a casket lid 220 formed from a suitable plastic or composite material. According to another embodiment, the casket 200 may be formed or fabricated from a metal material. For both types of materials, the outer surface does not require a finished treatment because as will be described in more detail below, the customized (or personalized) outer covering or layer finishes the exterior of the casket 200. According to an embodiment of the invention, the casket underbody 200 is finished with an outer covering or customized treatment as discussed in more detail below.

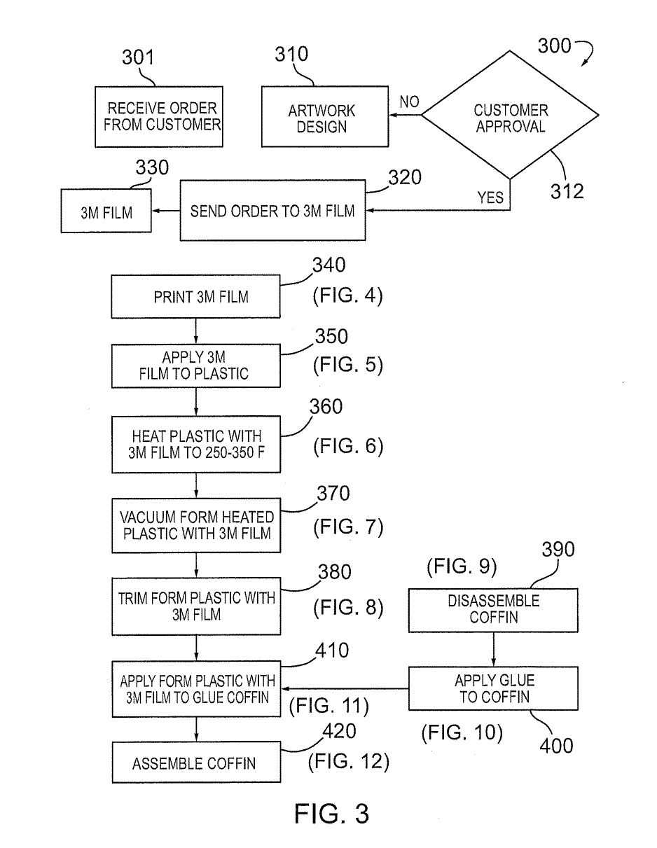

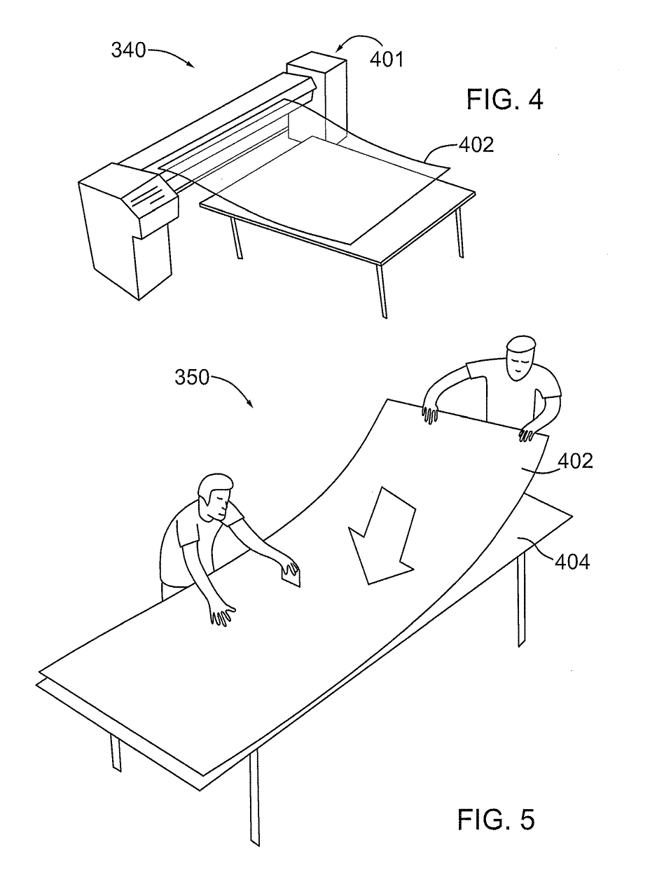

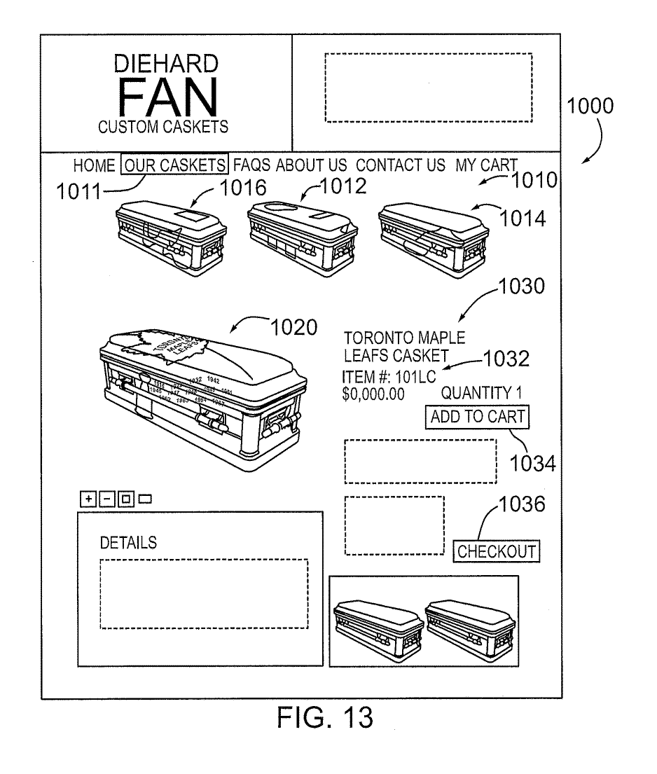

Reference is next made to FIG. 3, which shows a process or method for fabricating or making a casket with personalized or customized outer covering according to an embodiment of the present invention, and indicated generally by reference 300. As shown, the first step in process 300 comprises receiving an order for a customizable casket, and is indicated generally by reference 301. The order can be generated manually, for example, at a funeral home, or according to another embodiment, the order may be generated electronically, for example, online and utilizing a webpage or website according to another embodiment of the present invention, and as depicted in FIG. 13. The next step indicated by reference 310 involves generating the artwork or design for the outer covering that will be applied to the casket underbody 200. As shown in FIG. 3, the casket fabrication process 300 may include a customer approval step indicated generally by reference 312. The customer approval step comprises the customer approving the artwork design prior to proceeding further with the casket fabrication. The next step indicated by reference 320 comprises fabricating or producing a thin film with the artwork design. According to an exemplary embodiment or implementation, the thin film comprises a thin film substrate manufactured by the 3M™ Corporation. It will be appreciated that other types of suitable thin film materials with the artwork design applied may be used in accordance with an embodiment of the present invention. The thin film outer covering is made-to-order with the artwork design applied, as indicated by reference 330. For a 3M film, the next step indicate by reference 340 involves utilizing a 3M film printing machine 401 to print a thin film with the applied artwork design 402, as depicted in FIG. 4.

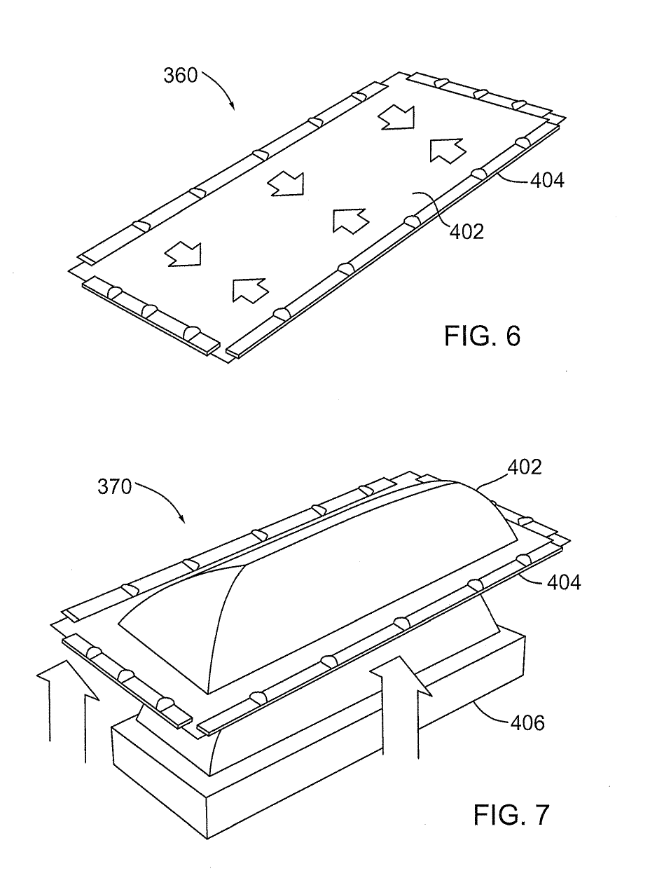

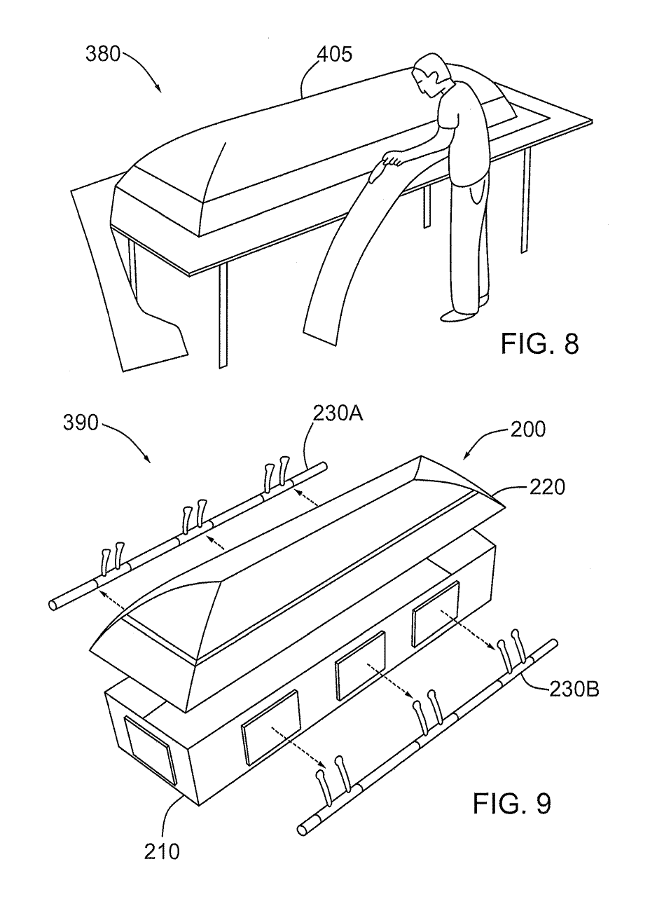

Reference is next made to FIG. 5, which shows in diagrammatic form the next step indicated generally by reference 350. As depicted, step 350 involves applying the printed 3M thin film 402 to a plastic sheet indicated by reference 404. The plastic sheet 404 provides a substrate, or a base layer, for holding the thin film 402 for subsequent heating and forming and application to the casket, as described in more detail below. According to an exemplary embodiment, the plastic sheet 404 has thickness of 2 to 3 mil, and may be formed of polyethylene or another plastic material suitable for heating forming in accordance with the embodiments of present invention. As shown in FIG. 6 and indicated generally by reference 360, the thin film 402 and the plastic sheet 404 are heated. For 3M film, the heating temperature ranges from about 250 F to 350 F. In known manner, the heating step 360 serves to bond the 3M film 402 and the plastic sheet (i.e. base layer) 404. The next step depicted in FIG. 7 and indicated generally by reference 370 involves forming the bonded 3M film 402 and the plastic sheet 404 to conform to the contours and/or shape of the casket underbody 200 (i.e. the casket lid 220 and the casket body 210). As depicted in FIG. 7, the thin film 402 and plastic sheet 404 are applied to a vacuum form 406 and heated to form the shape of the thin film 402 and the plastic sheet 404. The vacuum form or mold 406 shown in FIG. 7 is configured for the forming the thin film and plastic sheet to the shape of the casket lid 220 (FIG. 9). Similar processing steps and vacuum forming techniques are utilized and repeated for forming the thin film 402 and the plastic sheet 404 for other sections or surfaces of the casket underbody 210. If the casket underbody is designed with contours and other shaped elements, for example, as included in the casket body 210 shown in FIG. 9, then vacuum forming techniques as described above with reference to FIG. 7 are utilized to form these sections. Next in step 380, the vacuum formed thin film 402 and plastic sheet 404, indicated by reference 405, is trimmed as shown in FIG. 8.

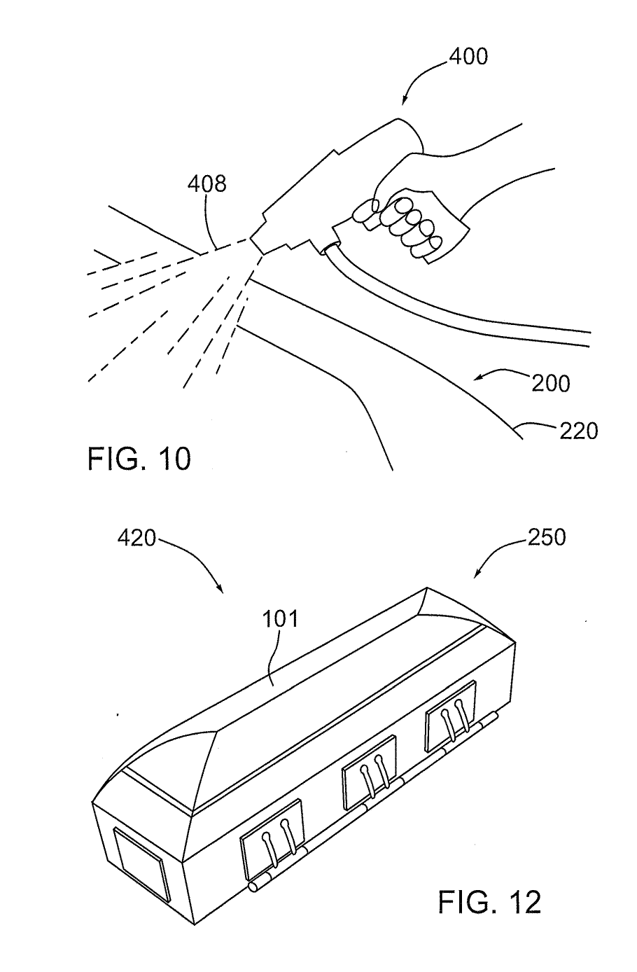

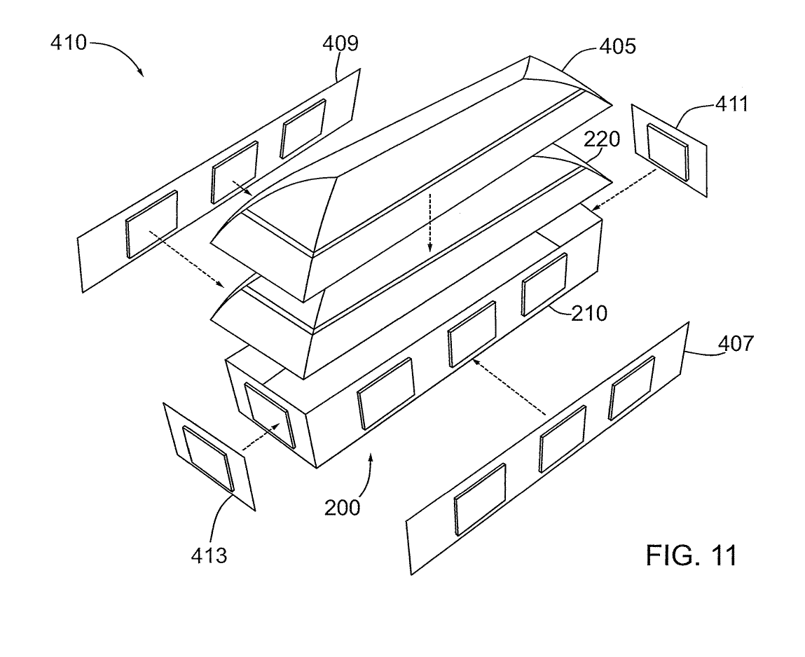

According to an embodiment, the casket 200 is disassembled, i.e. the casket body 210 and the casket lid 220 are separated, and the handles 230 are removed from the casket body 210, as shown in FIG. 9 and indicated generally by step 390. Next in step 400, an adhesive or glue 408 is applied to the casket lid 220 as shown in FIG. 10. The vacuum formed thin film and plastic sheet 405 is then applied to the casket lid 220 as shown in FIG. 11 and indicated generally be reference 410. As also depicted in FIG. 10, these steps are repeated for formed thin film and plastic sheet side sections 407 and 409, and formed thin film and plastic end sections 411 and 413, which are applied to the casket body 210. Once all of the thin film and plastic sheet sections have been applied to the casket underbody 200, the casket lid 220 is attached to the casket body 210 and the handles 230 are installed to produce a finished casket 250 as shown in FIG. 12, with a customized or personalized outer covering, for example, the Toronto Maple Leafs 101 (FIG. 1) or a beloved pet theme 103 (as shown in FIG. 2). It will be appreciated that the combination of the plastic layer and the bonded thin film layer as described above facilitates the handling and application of the thin layer (with customized graphics or artwork design(s)) to the casket 200 without additional finishing steps commonly associated with the application of a thin film. The elimination of extra finishing steps, and/or additional finishing time, facilitates the fabrication and turn-around time of custom made-to-order caskets, for example, providing a turn-around time of 24 to 48 hours for a casket requisitioned utilizing an on-line ordering system, for example, as depicted in FIG. 13.

Reference is next made to FIG. 13, which shows a screen shot of a graphical user interface for a casket order system or platform according to an embodiment of the present invention and indicated generally by reference 1000 and comprising a computer program configured to allow an individual to custom design or personalize and order a casket for a loved one or his/her self. The graphical user interface (and associated computer program) for the casket order system 1000 may be implemented as a stand-alone computer program or as a web based page accessed over the Internet through a web browser.

As shown in FIG. 13, the casket order system 1000 implemented as a web page comprises a casket select window or panel indicated generally by reference 1010 and implemented as a scrollable window. In response to a user input, the casket order system 1000 is configured to display the selected casket in another window or panel indicated by reference 1020. The casket order system 1000 includes an order confirmation window or panel indicated by reference 1030 and configured to finalize the casket order. According to an exemplary implementation, the order confirmation window 1030 is configured with a price field 1032, an “Add to Cart” button 1034 and a “Checkout” button 1036 (to complete the checkout or order process). It will be appreciated that combining the casket order system 1000 with the casket fabrication process according to the embodiments of the present invention provides a facility or system in which a casket with a customized treatment (e.g. artwork design) can be ordered and expeditiously fabricated and then delivered to a funeral home, without the need to stock a large inventory of finished caskets.

The functionality and features associated with the casket order system or platform 1000 (FIG. 13) as described above and in accordance with the embodiments may be implemented in the form of one or more software objects, code components, executable statements and machine readable code, computer programs or program modules in the server and/or the partner machines or computers. Further, at least some or all of the software objects, executable statements, machine readable computer code, components or modules can be hard-coded into processing units and/or read only memories or stored or embedded on computer readable media, storage media, or other digital storage media or non-volatile storage media in the computers, computer systems, servers and/or other components or modules depicted in the drawings. The specific implementation details and coding details for the computer programs, software objects and/or program modules will be within the knowledge and understanding of one skilled in the art.

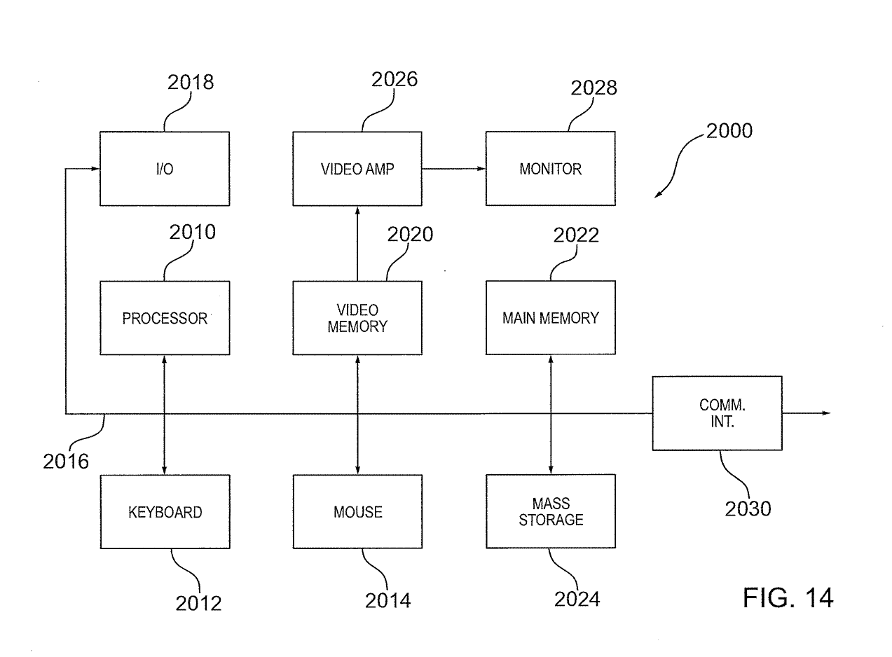

Reference is next made to FIG. 14, which shows an exemplary implementation of a computer system 2000 according to an embodiment and suitable for the casket order system 1000 (FIG. 13).

As shown, the computer system 2000 comprises a processor 2010 and a keyboard 2012 and mouse 2014 coupled to the processor 2010 via a system bus 2016. The keyboard 2012 and the mouse 2014, in one example, allow a user to introduce or provide inputs to computer system 2000 and the processor 2010. It will be appreciated that other suitable input devices may be used in addition to, or in place of, the mouse 2014 and/or the keyboard 2012. The computer system 2000 may be configured with other input/output (I/O) devices 2018 coupled to the system bus 2016, for example, a printer, audio/video (A/V) I/O, etc.

According to another aspect, the computer system 2000 may include a video memory module 2020, a main memory module 2022 and a mass storage device 2024, which are coupled to the system bus 2016. The mass storage device 2024 may include both fixed and removable media, such as magnetic, optical or magnetic optical storage systems and any other available mass storage technology. The system bus 2016 may be configured, for example, with address lines for addressing the video memory 2020 and/or the main memory 2024.

According to another aspect, the system bus 2016 may include a data bus for transferring data between and among the components, such as the processor 2010, the main memory 2022, the video memory 2020 and/or the mass storage device 2024. The video memory 844 may be a dual-ported video random access memory. One port of the video memory 2020, in one example, is coupled to a video amplifier 2026, which is used to drive one or more monitor(s) indicated generally by reference 2028. The monitor(s) 2028 may be any type of monitor suitable for displaying graphic images, such as a cathode ray tube monitor (CRT), flat panel, or liquid crystal display (LCD) monitor or any other suitable data presentation device. The processor 2010 may be implemented utilizing any suitable microprocessor or microcomputer.

According to another aspect, the computer system 2000 may include a communication interface 2030 which is coupled to the system bus 2016. The communication interface 2030 provides a two-way data communication coupling via a network link. For example, the communication interface 2030 may be a satellite link, a local area network (LAN) card, a cable modem, and/or wireless interface. In any such implementation, the communication interface 2030 is configured to send and/or receive electrical, electromagnetic or optical signals that carry digital data representing various types of information.

According to another aspect, code received by the computer system 2000 may be executed by the processor 2010 as the code is received, and/or stored in the mass storage 2024, or other non-volatile storage for later execution. In this manner, the computer system 2000 may obtain program code in a variety of forms. Program code may be embodied in any form of computer program product such as a medium configured to store or transport computer readable code or data, or in which computer readable code or data may be embedded. Examples of computer program products include CD-ROM discs, ROM cards, floppy disks, magnetic tapes, computer hard drives, servers on a network, and solid state memory devices. Regardless of the actual implementation of the computer system 2000, the data processing system may execute operations that allow for facilitating transactions between disparate retailers and disparate telecommunications carriers as described herein.

While the embodiments of the present invention were described in the context of a casket or burial coffin, it will be appreciated that the embodiments are applicable to urns and similar vessels or containers.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

1. (canceled)

2. (canceled)

3. (canceled)

4. (canceled)

5. (canceled)

6. (canceled)

7. (canceled)

8. (canceled)

9. (canceled)

10. A method for fabricating a casket with a customized exterior treatment, said method comprising the steps of:
fabricating a thin film layer;
applying said thin film layer to a substrate layer;
forming said substrate layer and said thin film layer to a shape corresponding to an exterior surface of the casket;
bonding said formed substrate layer and said thin film to the exterior surface of the casket.

11. The method as claimed in claim 10, wherein said step of fabricating said thin film layer comprises applying an artwork design to said thin film.

12. The method as claimed in claim 11, wherein said step of forming comprises form heating said substrate layer and said thin film layer utilizing a mold corresponding to the shape of a casket lid for said casket.

13. The method as claimed in claim 11, wherein said step of forming comprises form heating said substrate layer and said thin film utilizing one or more molds corresponding to the sides of a casket body for said casket.

14. The method as claimed in claim 12, further including the step of trimming said form heated substrate layer and thin film layer to a finished form prior to bonding to the exterior surface of the casket.

15. The method as claimed in claim 11, wherein said artwork design is based on wishes of a deceased.

16. The method as claimed in claim 15, wherein said artwork design applied to said thin film comprises a favourite sports team associated with the deceased.

17. The method as claimed in claim 14, wherein said substrate layer comprises a polyethylene plastic layer having a thickness from approximately 2 to 3 mil.

18. The method as claimed in claim 17, wherein said thin film comprises a thin film plastic printed or embossed with said artwork design.

19. The method as claimed in claim 18, wherein said thin film and said substrate layer are vacuum form heated at temperature in the range of 250 to 350 degrees F.

20. The method as claimed in claim 19, wherein said step of bonding comprises gluing said formed and trimmed substrate layer and thin film layer to an exterior surface of the casket.
